(19) United States
(12) Patent Application Publication
(10) Pub. No.: US 2019/0294081 A1
(43) Pub. Date: Sep. 26, 2019

(54) IMAGE FORMING APPARATUS

(71) Applicant: FUJI XEROX CO.,LTD., Tokyo (JP)

(72) Inventor: Noriaki KOJIMA, Kanagawa (JP)

(73) Assignee: FUJI XEROX CO.,LTD., Tokyo (JP)

(21) Appl. No.: 16/109,796

(22) Filed: Aug. 23, 2018

(30) Foreign Application Priority Data
Mar. 22, 2018 (JP) 2018-053757

(51) Int. Cl. G03G 15/16; G03G 15/00

(52) U.S. Cl. CPC G03G 15/161; G03G 15/6502

(57) ABSTRACT

An image forming apparatus includes a toner-image holding unit that transports a toner image to a transfer position, a sheet-guide unit that guides a sheet to the transfer position, and a transfer unit that transfers the unfixed toner image onto the sheet at the transfer position. The sheet-guide unit includes a projecting portion including a pair of end guide portions that project further toward the transfer position than an end edge does and that are arranged on opposite sides of a central guide portion in a width direction and the central guide portion that is disposed at the center position between the end guide portions in the width direction and that projects toward the transfer position while an amount of projection thereof decreases from its apex, which is closer to the transfer position than the end edge is, toward its opposite ends in the width direction.

### CROSS-REFERENCE TO RELATED APPLICATIONS

This application is based on and claims priority under 35 USC 119 from Japanese Patent Application No. 2018-053757 filed Mar. 22, 2018.

### BACKGROUND

### (i) Technical Field

The present invention relates to an image forming apparatus.

### (ii) Related Art

A guide member that is called the so-called chute, a guide plate, or the like that guides a sheet, which is transported thereto, to a transfer unit that transfers an unfixed toner image onto the sheet may sometimes be provided.

In a configuration in which such a guide member is provided, when the trailing end of a sheet that has been guided to a transfer unit by the guide member is separated from the guide member, there is a possibility that the sheet or a trailing end portion of the sheet will move rapidly in the in-plane direction thereof and will come into contact with a toner-image carrier, which has held and transported an unfixed toner image, due to, for example, the rigidity of the sheet or the angle at which the sheet enters the transfer unit, so that image defects such as image misalignment (or misregistration) and blurred (or faded) images will occur.

### SUMMARY

According to an aspect of the invention, there is provided an image forming apparatus including a toner-image holding unit that holds an unfixed toner image and transports the unfixed toner image to a transfer position; a sheet-guide unit that is brought into contact with a first surface of a sheet that is transported to the sheet-guide unit, the first surface facing the toner-image holding unit, and guides the sheet to the transfer position; and a transfer unit that nips the sheet, which is guided to the transfer unit by the sheet-guide unit, between the transfer unit and the toner-image holding unit at the transfer position and that transfers the unfixed toner image transported by the toner-image holding unit onto the sheet. The sheet-guide unit includes a projecting portion including a pair of end guide portions that project toward the transfer position further than a reference end edge does, the reference end edge facing the transfer position, and that are arranged on opposite sides of a central guide portion in a width direction that crosses a sheet-transport direction and the central guide portion that is disposed at the center position between the pair of end guide portions in the width direction and that projects toward the transfer position while an amount of projection of the central guide portion decreases from an apex of the central guide portion, which is closer to the transfer position than the end edge is, toward opposite ends of the central guide portion in the width direction.

### BRIEF DESCRIPTION OF THE DRAWINGS

An exemplary embodiment of the present invention will be described in detail based on the following figures, wherein:

FIG. 1 is a schematic diagram illustrating an overview of a printer that is an image forming apparatus according to an exemplary embodiment of the present invention;

FIG. 2 is an enlarged schematic diagram illustrating a portion that is indicated by a circle R in FIG. 1;

FIGS. 3A, 3B, and 3C are three-view diagrams illustrating a first example of a sheet-guide plate;

FIGS. 4A, 4B, 4C, and 4D are schematic diagrams illustrating a sheet-guide plate having a structure of the related art and a sheet that is being guided by the sheet-guide plate and transported toward a second transfer position;

FIGS. 5A, 5B, and 5C are schematic diagrams illustrating a sheet-guide plate having a structure in which a flexible member having a shape similar to that of a central-guide flexible member in the first example illustrated in FIGS. 3A to 3C is joined to a guide member;

FIGS. 6A and 6B are diagrams illustrating an operation of the sheet-guide plate, which is the first example illustrated in FIGS. 3A to 3C, on a normal sheet;

FIG. 7 is a schematic plan view illustrating a second example of the sheet-guide plate;

FIG. 8 is a schematic plan view illustrating a third example of the sheet-guide plate;

FIGS. 9A and 9B are schematic diagrams illustrating a fourth example of the sheet-guide plate;

FIGS. 10A and 10B are schematic diagrams illustrating a fifth example of the sheet-guide plate;

FIGS. 11A and 11B are schematic diagrams illustrating a sixth example of the sheet-guide plate;

FIGS. 12A and 12B are schematic diagrams illustrating a seventh example of the sheet-guide plate;

FIGS. 13A, 13B, and 13C are schematic diagrams illustrating an eighth example of the sheet-guide plate; and

FIGS. 14A, 14B, and 14C are schematic diagrams illustrating a ninth example of the sheet-guide plate.

### DETAILED DESCRIPTION

An exemplary embodiment of the present invention will be described below.

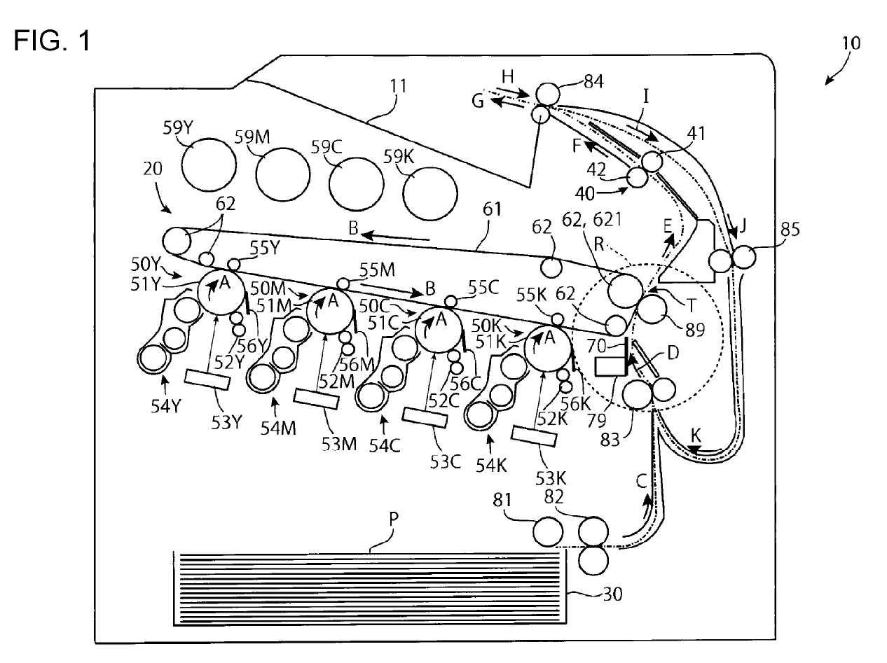

FIG. 1 is a schematic diagram illustrating an overview of a printer that is an image forming apparatus according to the exemplary embodiment of the present invention.

A printer 10 includes an image forming unit 20 that forms toner images and a sheet tray 30 that is disposed below the image forming unit 20 and that is capable of being drawn out. Sheets P that are used in image formation and on which images have not yet been formed are stacked on top of one another in the sheet tray 30. When image formation is performed, one of the sheets P is taken out from the sheet tray 30, and after an image has been formed on the sheet P, which has been taken out, the sheet P is ejected to a sheet ejection tray 11 that is provided in an upper portion of the printer 10. Note that, in the printer 10, several types of sheets such as, for example, postcards and A4 normal sheets may be used. When a sheet that is different in type from the sheets that have previously been used in the printer 10, the sheets accommodated in the sheet tray 30 are changed.

An image formation process in the printer 10 will be described below.

The image forming unit 20 includes four image forming engines 50Y, 50M, 50C, and 50K that are disposed in a side-by-side arrangement. The image forming engines 50Y, 50M, 50C, and 50K are engines that form toner images by using toners of yellow (Y), magenta (M), cyan (C), and black (K), respectively. The image forming engines 50Y, 50M, 50C, and 50K have the same configuration except with regard to the differences between the colors of toners to be used. In the following description, the letters Y, M, C, and K denoting the colors will be omitted when it is not necessary to distinguish the image forming engines 50Y, 50M, 50C, and 50K and other components in terms of color, and the image forming engines 50Y, 50M, 50C, and 50K and the other components will be denoted by reference signs only including numbers.

Each of the image forming engines 50 includes a photoconductor drum 51 that rotates in the direction of arrow A. Each of the image forming engines 50 further includes a charger 52, an exposure unit 53, a developing unit 54, a transfer device 55, and a cleaner 56 that are disposed around the photoconductor drum 51.

Each of the chargers 52 uniformly charges a surface of the corresponding photoconductor 51.

Each of the exposure units 53 radiates exposure light, which has been modulated in accordance with image data, onto the corresponding photoconductor 51 so as to form an electrostatic latent image on the surface of the photoconductor 51.

The color toners (toners of Y, M, C, and K), which correspond to the respective image forming engines 50Y, 50M, 50C, and 50K, are each contained in one of the developing units 54. Each of the developing units 54 develops, with the toner contained therein, an electrostatic latent image formed on the corresponding photoconductor drum 51 so as to form a toner image onto the photoconductor drum 51.

An intermediate transfer belt 61 is disposed above the four image forming engines 50Y, 50M, 50C, and 50K, which are disposed in a side-by-side arrangement. The intermediate transfer belt 61 is an endless belt and is stretched by plural rollers 62. The intermediate transfer belt 61 moves circularly in the direction of arrow B on a circular-movement path extending along the four image forming engines 50Y, 50M, 50C, and 50K.

Four toner cartridges 59Y, 59M, 59C, and 59K that respectively contain the color toners (toners of Y, M, C, and K) are disposed above the intermediate transfer belt 61. When the amount of the toner contained in one of the developing units 54, which is included in one of the image forming engines 50, has decreased, the developing unit 54 is replenished with the toner from the corresponding toner cartridge 59.

The transfer devices 55 of the image forming engines 50 are disposed in a space enclosed by the intermediate transfer belt 61 at positions where the intermediate transfer belt 61 is interposed between the transfer devices 55 and the respective photoconductor drums 51. Toner images formed on the photoconductor drums 51 are transferred onto the intermediate transfer belt 61 by operation of the transfer devices 55. Here, four toner images formed by the four image forming engines 50Y, 50M, 50C, and 50K are sequentially transferred onto the intermediate transfer belt 61 in such a manner as to be superposed with one another along with the circular movement of the intermediate transfer belt 61.

The cleaners 56 clean the respective photoconductor drums 51 by removing unnecessary toner remaining on the photoconductor drums 51 after toner images have been transferred.

Toner images that have been sequentially transferred to the intermediate transfer belt 61 in such a manner as to be superposed with one another are transported by the intermediate transfer belt 61. Then, at a second transfer position T at which a backup roller 621 that is one of the plural rollers 62, by which the intermediate transfer belt 61 is stretched, and a second transfer roller 89 face each other with the intermediate transfer belt 61 interposed therebetween, the toner images are transferred onto one of the sheets P by operation of the second transfer roller 89. Unnecessary toner remaining on the intermediate transfer belt 61 after the toner images have been transferred to the sheet P is removed from the intermediate transfer belt 61 by a cleaner 64.

Here, the intermediate transfer belt 61 according to the present exemplary embodiment corresponds to an example of a toner-image holding unit according to an aspect of the present invention, and the second transfer roller 89 according to the present exemplary embodiment corresponds to an example of a transfer unit according to an aspect of the present invention.

The sheets P, which are accommodated in the sheet tray 31, are taken out by a pickup roller 81. When some of the sheets P are taken out while superposed with each other, one of the sheets P is separated from the rest of sheets P by separation rollers 82 with certainty, and the one sheet P is transported in the direction of arrow C to timing-adjustment rollers 83.

Then, the timing at which the sheet P is transported to the second transfer position T is adjusted so as to be synchronized with the timing at which toner images that have been transferred to the intermediate transfer belt 61 are transported to the second transfer position T, and the sheet P is sent out by the timing-adjustment rollers 83 in the direction of arrow D. The sheet P, which is sent out, is guided to the second transfer position T by a sheet-guide plate 70 that is supported by a support member 79. The sheet-guide plate 70 is a member that is brought into contact with a first surface of the sheet P facing the intermediate transfer belt 61 and guides the sheet P to the second transfer position T. Then, at the second transfer position T, the toner images on the intermediate transfer belt 61 are transferred onto the first surface of the sheet P by operation of the second transfer roller 89. The sheet-guide plate 70 corresponds to an example of a sheet-guide unit according to an aspect of the present invention.

The sheet P to which the toner images have been transferred is further transported in the direction of arrow E and passes through a fixing device 40. The fixing device 40 includes a pressure roller 41 and a heating roller 42. The sheet P transported to the fixing device 40 is nipped between the pressure roller 41 and the heating roller 42, and heat and pressure are applied to the sheet P, so that the toner images on the sheet P are fixed onto the sheet P.

The sheet P that has passed through the fixing device 40 is further transported in the direction of arrow F and is ejected by sheet-ejection rollers 84 in the direction of arrow G to the sheet ejection tray 11 that is provided above the image forming unit 20.

The printer 10 is capable of forming images onto the two surfaces of each of the sheets P. When images are formed onto the two surfaces of one of the sheets P, first, an image is formed on the first surface of the sheet P in a manner similar to the above, and the sheet P having the image formed on the first surface thereof is sent out to some extent by the sheet-ejection rollers 84 in the direction of arrow G to the sheet ejection tray 11. Then, the sheet-ejection rollers 84 rotate in a reverse direction in a state where the sheet P is still nipped between the sheet-ejection rollers 84. As a result, the sheet P is moved in the direction of arrow H this time and further transported in the directions of arrows I and J. Subsequently, the sheet P is further transported in the direction of arrow K by transport rollers 85 and reaches the timing-adjustment rollers 83 again. After that, an image is formed onto the second surface of the sheet P this time in a manner similar to that of the image formation performed on the first surface. Then, the sheet P having the image formed on the second surface thereof is ejected to the sheet ejection tray 11.

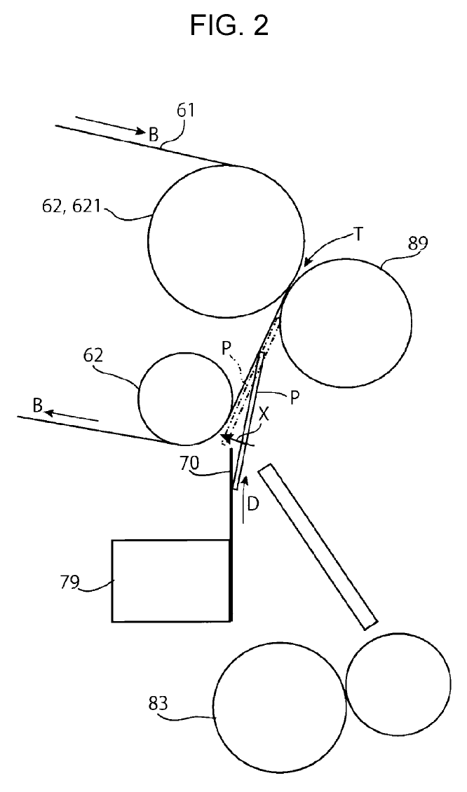

FIG. 2 is an enlarged schematic diagram illustrating a portion that is indicated by a circle R in FIG. 1.

FIG. 2 illustrates a state in which one of the sheets P is guided by the sheet-guide plate 70 and transported to the second transfer position T. The sheet P is moved in the direction of arrow D toward the second transfer position T while being guided by the sheet-guide plate 70, and when the trailing end of the sheet P is separated from the sheet-guide plate 70, the trailing end of the sheet P moves in the direction of arrow X upon the separation of the trailing end of the sheet P from the sheet-guide plate 70, and the sheet P comes into contact with the intermediate transfer belt 61 as indicated by a one-dot chain line. If the trailing end of the sheet P moves in the direction of arrow X rapidly or irregularly, the sheet P will cause irregularities in the toner images on the intermediate transfer belt 61, which in turn results in image defects such as image misalignment (or misregistration) and blurred (or faded) images.

The structure of the sheet-guide plate 70 for making the above-mentioned movement gentle will be described below. Several examples of the sheet-guide plate 70 will now be described, and in the following description, in order to distinguish the examples of the sheet-guide plate 70, the reference letters A, B, and so on are added so that the examples will be referred to as sheet-guide plates 70A, 70B, and so on. However, when it is not necessary to distinguish the examples, the examples will be referred to as the sheet-guide plates 70.

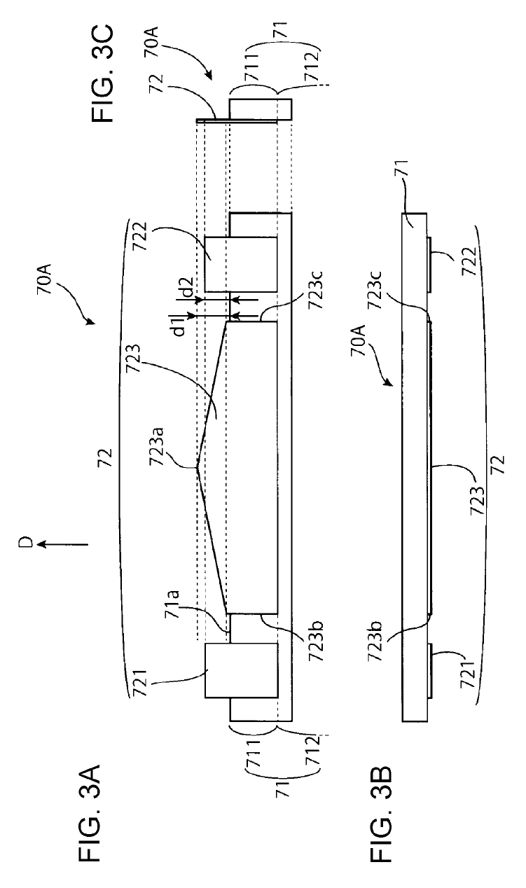

FIGS. 3A to 3C are a three-view diagram illustrating a first example of the sheet-guide plate. FIG. 3A, FIG. 3B, and FIG. 3C are respectively a plan view, a front view, and a side view.

In FIGS. 3A to 3C, only an end portion of a sheet-guide plate 70A that is close to the second transfer position T (see FIG. 1 and FIG. 2) is illustrated. The sheets P (see FIG. 1 and FIG. 2) are guided by the sheet-guide plate 70A in the direction of arrow D toward the second transfer position T.

The sheet-guide plate 70A includes a guide member 71 that is a body of the sheet-guide plate 70A and a film-shaped flexible member 72 that is adhesively fixed to an end portion 711 of the guide member 71, the end portion 711 being located on the side on which the second transfer position T is present. Although only a portion in the vicinity of the end portion 711 is illustrated, a portion 712 of the guide member 71 excluding the end portion 711 actually further extends toward an upstream side in a sheet-transport direction (in a direction opposite to the direction of arrow D).

The flexible member 72 is formed of, for example, a polyethylene terephthalate (PET) film and is separated into a pair of end-guide flexible members 721 and 722 and a central-guide flexible member 723, and the pair of end-guide flexible members 721 and 722 and the central-guide flexible member 723 are joined to the end portion 711 of the guide member 71. Here, an end edge 71a of the guide member 71 that is located on the side on which the second transfer position T is present (the side indicated by arrow D) is an example of a reference end edge according to an aspect of the present invention. The pair of end-guide flexible members 721 and 722 are positioned at opposite sides of the guide member 71 in a width direction of the guide member 71 (the transverse direction in FIG. 3A) that crosses the sheet-transport direction, which is indicated by arrow D, and project so as to be closer to the second transfer position T than the reference end edge 71a is. The central-guide flexible member 723 is disposed at the center position between the pair of end-guide flexible members 721 and 722 in the width direction. The central-guide flexible member 723 has a projecting shape in which the amount of projection thereof decreases from a predetermined apex 723a (here, the apex 723a is located at the center in the width direction of the central-guide flexible member 723) to opposite ends of the central-guide flexible member 723 in the width direction.

The pair of end-guide flexible members 721 and 722 and the central-guide flexible member 723 are film-shaped flexible members, and thus, portions of the pair of end-guide flexible members 721 and 722 and a portion of the central-guide flexible member 723 that project beyond the reference end edge 71a have flexibility and are deformed as a result of a force being applied thereto by one of the sheets P. The first example has a configuration in which the flexible member 72 (the pair of end-guide flexible members 721 and 722 and the central-guide flexible member 723) is provided in addition to the guide member 71 and in which the flexible member 72 is joined to the guide member 71, so that flexibility is easily given to the portions projecting beyond the end edge 71a.

In the first example illustrated in FIGS. 3A to 3C, the configuration of a combination of the end-guide flexible members 721 and 722 and portions of the end portion 711 of the guide member 71 to which the end-guide flexible members 721 and 722 are joined corresponds to an example of a pair of end guide portions according to an aspect of the present invention. Similarly, the configuration of a combination of the central-guide flexible member 723 and a portion of the end portion 711 of the guide member 71 to which the central-guide flexible member 723 is joined corresponds to an example of a central guide portion according to an aspect of the present invention. In addition, the configuration of a combination of the end portion 711 of the guide member 71 and the flexible member 72, which includes the pair of end-guide flexible members 721 and 722 and the central-guide flexible member 723, corresponds to an example of a projecting portion according to an aspect of the present invention.

In the sheet-guide plate 70A, the amount of projection of the apex 723a of the central-guide flexible member 723 from the end edge 71a is equal to or larger than the amount of projection of each of the end-guide flexible members 721 and 722 from the end edge 71a. More specifically, in the sheet-guide plate 70A, as illustrated in FIGS. 3A to 3C, when comparing the projecting amount d1 of the apex 723a from the end edge 71a and the projecting amount d2 of each of the end-guide flexible members 721 and 722 from the end edge 71a, the relationship of d1>d2 is satisfied.

In addition, in the sheet-guide plate 70A, which is the first example, opposite end edges 723b and 723c of the central-guide flexible member 723 in the width direction extend so as to project beyond the end edge 71a. A portion of the central-guide flexible member 723 that does not project beyond the end edge 71a is a portion that is joined to the guide member 71 and does not help absorb impact when one of the sheets P is separated from the sheet-guide plate 70A. In the first example, causing the opposite end edges 723b and 723c to project beyond the end edge 71a enables the entire central-guide flexible member 723 in the width direction to deform, and this deformation helps absorb impact.

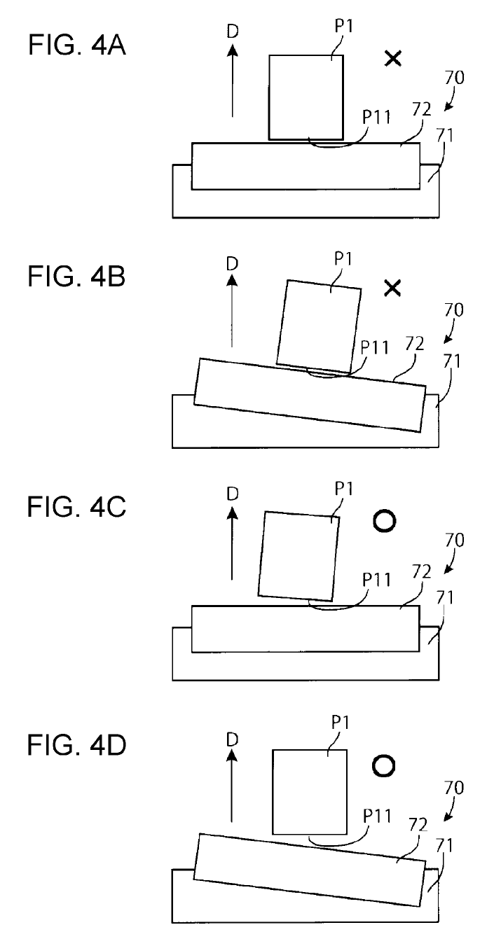

FIGS. 4A to 4D are schematic diagrams illustrating a sheet-guide plate having a structure of the related art and a sheet that is being guided by the sheet-guide plate and transported toward the second transfer position. The sheet-guide plate illustrated in FIGS. 4A to 4D has a structure of the related art and corresponds to a comparative example for the exemplary embodiment of the present invention. Here, for ease of understanding, as in the first example illustrated in FIGS. 3A to 3C, the terms “sheet-guide plate 70”, “guide member 71”, and “flexible member 72” will be used as they are.

A sheet-guide plate 70 having a structure of the related art includes a guide member 71 and a flexible member 72 that has a rectangular shape and that is joined to the guide member 71. Here, a postcard-size thick sheet P1 is being guided in the direction of arrow D by a center portion of the sheet-guide plate 70 in a width direction of the sheet-guide plate 70. The postcard-size sheet P1 has a small width, and thus, the sheet P1 is transported without a member supporting and guiding a side edge of the sheet Pl. Consequently, the sheet P1 may sometimes be transported while being tilted as illustrated in FIGS. 4B and 4C.

FIG. 4A illustrates a state in which the flexible member 72 is joined to the guide member 71 in a correct position and in which the sheet P1 is being guided in a correct position. In this case, the entire trailing end edge P11 of the sheet P1 in a width direction of the sheet P1 is separated from the flexible member 72 at one time. In this case, the sheet P1 receives a large impact, and the sheet P1 moves rapidly in the direction of arrow X illustrated in FIG. 2. As a result, the sheet P1 abuts strongly against the intermediate transfer belt 61, and it is very likely that an image defect will occur.

FIG. 4B illustrates a state in which the flexible member 72 is joined to the guide member 71 in a tilted position and in which the sheet P1 is being guided in a position in which the sheet P1 and the flexible member 72 are tilted in the same direction at the same angle. Also in this case, the entire trailing end edge P11 of the sheet P1 in the width direction is separated from the flexible member 72 at one time, and it is very likely that an image defect will occur.

In contrast, FIG. 4C illustrates a state in which the flexible member 72 is joined to the guide member 71 in a correct position and in which the sheet P1 is being guided in a tilted position. In this case, the trailing end edge P11 of the sheet P1 is slowly separated from the flexible member 72 over time.

FIG. 4D illustrates a state in which the flexible member 72 is joined to the guide member 71 in a tilted position and in which the sheet P1 is being guided in a correct position. Also in this case, the trailing end edge P11 of the sheet P1 is slowly separated from the flexible member 72 over time.

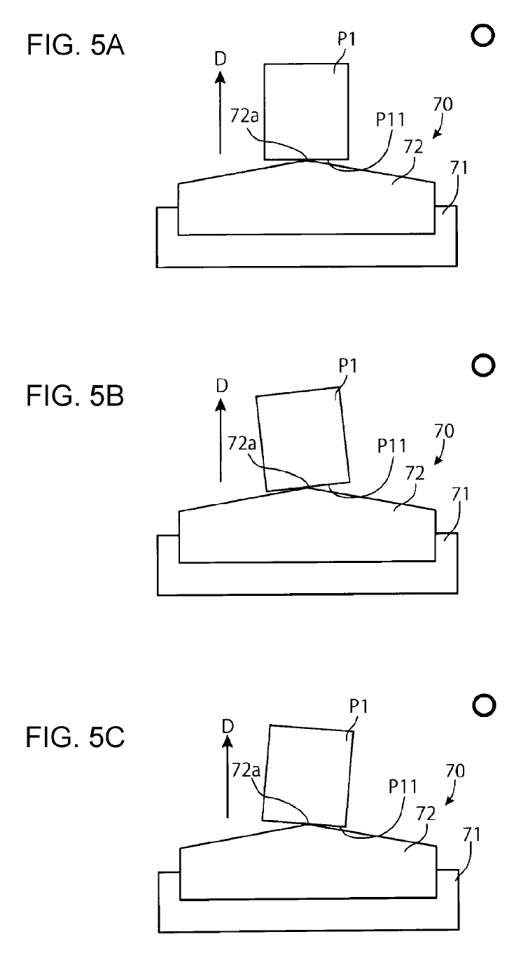

FIGS. 5A to 5C are schematic diagrams illustrating a sheet-guide plate having a structure in which a flexible member having a shape similar to that of the central-guide flexible member in the first example illustrated in FIGS. 3A to 3C is joined to a guide member. An operation of the central-guide flexible member 723, which is included in the flexible member 72 illustrated in FIGS. 3A to 3C, on a small-sized thick sheet, such as a post card, will now be described with reference to FIGS. 5A to 5C.

The flexible member 72 illustrated in FIGS. 5A to 5C has an apex 72a projecting most at the center of the flexible member 72 in a width direction of the flexible member 72 and has a shape in which the amount of projection of the flexible member 72 decreases from the apex 72a to the left and right ends of the flexible member 72 in the width direction. FIG. 5A illustrates a state in which the postcard-size thick sheet P1 is being transported in a correct position. FIG. 5B illustrates a state in which the sheet P1 is being transported in a slightly tilted position. FIG. 5C illustrates a state in which the sheet P1 is being transported in a position in which the sheet P1 is tilted in a direction opposite to the direction in which the sheet P1 illustrated in FIG. 5B is tilted.

When the flexible member 72 is formed into a mountain-like projecting shape as illustrated in FIGS. 5A to 5C, the trailing end edge P11 of the sheet P1 is slowly separated from the flexible member 72 both in the case where the sheet P1 is transported in a correct position as illustrated in FIG. 5A and in the case where the sheet P1 is transported in a slightly tilted position as illustrated in FIGS. 5B and 5C.

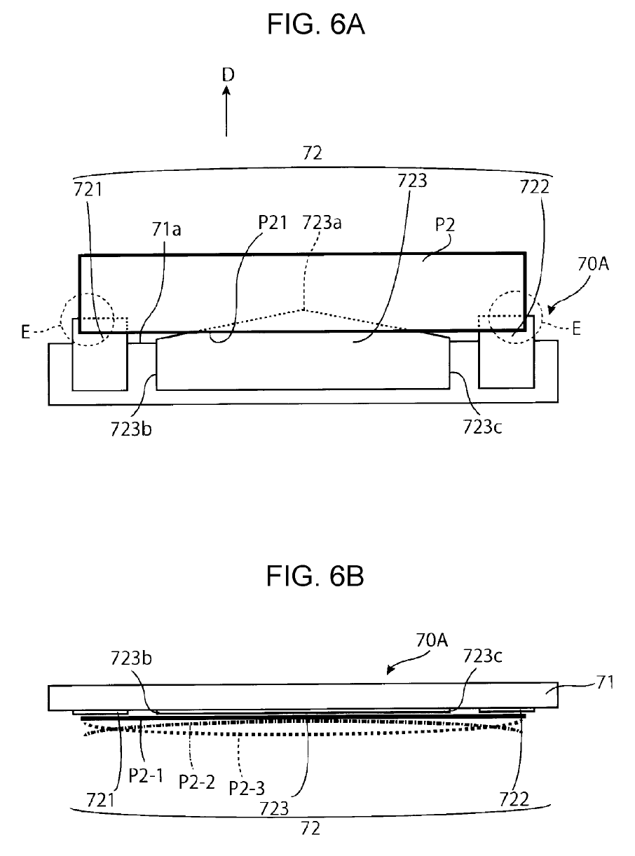

FIGS. 6A and 6B are diagrams illustrating an operation of the sheet-guide plate, which is the first example illustrated in FIGS. 3A to 3C, on a normal sheet.

FIGS. 6A and 6B illustrate a sheet P2 moving in the direction of arrow D while being guided by the sheet-guide plate 70A, which is also illustrated in FIGS. 3A to 3C. Although only a portion in the vicinity of the trailing end edge P21 of the sheet P2 is illustrated in FIGS. 6A and 6B, the sheet P2 further extends in the direction of arrow D.

The sheet P2 is a large-sized sheet having a size within a range usable in the printer 10 (see FIG. 1) and is, for example, an A4 normal sheet that has flexibility unlike a thick sheet such as a postcard.

In the sheet-guide plate 70A, which is the first example, as described with reference to FIGS. 3A to 3C, the amount of projection of the apex 723a of the central-guide flexible member 723 is larger than the amount of projection of each of the end-guide flexible members 721 and 722. Thus, when the trailing end edge P21 of the sheet P2 moving in the direction of arrow D is separated from the sheet-guide plate 70A, first, the left and right end portions of the sheet P2 are respectively separated from the end-guide flexible members 721 and 722, and the sheet P2 is brought into a state of being supported only by the apex 723a of the central-guide flexible member 723. Then, the entire trailing end edge P21 of the sheet P2 is separated from the sheet-guide plate 70A. Contrary to this, in the case where the amount of projection of each of the end-guide flexible members 721 and 722 is larger than the amount of projection of the apex 723a of the central-guide flexible member 723, the end portions thereof in the width direction are kept supported by the respective end-guide flexible members 721 and 722 until the sheet P2 eventually separates from the sheet-guide plate 70. This case is similar to the case where the trailing end edge P21 of the sheet P2 is separated from the sheet-guide plate 70 at one time, and there is a possibility that an effect of causing the sheet P2 to slowly separate from the sheet-guide plate 70 will be reduced. Therefore, as in the first example, it is preferable that the amount of projection of the apex 723a of the central-guide flexible member 723 be larger than that of each of the end-guide flexible members 721 and 722.

The end-guide flexible members 721 and 722 have another function with respect to the sheet P2, which is a normal sheet.

The printer 10 illustrated in FIG. 1 is a printer capable of forming images onto the two surfaces of each of the sheets P. Thus, when images are formed onto the two surfaces of one of the sheets P, the sheet P is caused to pass through the fixing device 40 for forming an image on the first surface of the sheet P, and then the sheet P is guided to the sheet-guide plate 70A again when an image is formed onto the second surface of the sheet P.

FIG. 6B illustrates sheets P2-1, P2-2, and P2-3 in three different forms. The sheets P2-1, P2-2, and P2-3 in three different forms are sheets P2 in the same form before an image forming operation is performed thereon. Among the sheets P2-1, P2-2, and P2-3 in three different forms, the sheet P2-1 is a sheet having no curl. The sheet P2-2 is a sheet that is curled in such a manner that a center portion of the sheet P2-2 in a width direction of the sheet P2-2 is in contact with the sheet-guide plate 70A, whereas the end portions of the sheet P2-2 in the width direction are separated from the sheet-guide plate 70A. The sheet P2-3 is curled in a direction opposite to the direction in which the sheet P2-2 is curled, and the end portions of the sheet P2-3 in a width direction of the sheet P2-3 are in contact with the sheet-guide plate 70A, whereas a center portion of the sheet P2-3 in the width direction is separated from the sheet-guide plate 70A. These curls are generated because of the fixing device 40, and whether a curl is generated in the direction in which the sheet P2-2 is curled or in the direction in which the sheet P2-3 is curled depends on the structure of the fixing device 40.

A function that will be described below is particularly effective in the case of the sheet P2-3, which is one of the sheets P2-1, P2-2, and P2-3 in three different forms and which is curled in the direction in which the center portion thereof is separated from the sheet-guide plate 70A.

If the end-guide flexible members 721 and 722 are not provided, when the trailing end edge P21 of the sheet P2 is separated from the end edge 71a of the guide member 71, the end portions of the sheet P2 that are indicated by circles E in FIG. 6A droop toward the intermediate transfer belt 61 (see FIG. 1 and FIG. 2) and come into contact with toner images on the intermediate transfer belt 61, and there is a possibility that an image defect will occur. The end-guide flexible members 721 and 722 have a function of supporting the ends of a trailing end portion of the sheet P2 until the trailing end edge P21 of the sheet P2 comes close enough to the intermediate transfer belt 61 and then releasing the ends of the trailing end portion of the sheet P2. In the first example, the end-guide flexible members 721 and 722 deform together with the central-guide flexible member 723, and this deformation brings the portions of the sheet P2 indicated by circles E closer to the intermediate transfer belt 61 before the portions of the sheet P2 are separated from the end-guide flexible members 721 and 722.

The above description of the first example has been completed, and a second example and the subsequent examples will be described below. Note that, in the following descriptions of the examples, elements that correspond to the elements of the sheet-guide plate 70A, which is the first example, are denoted by the same reference signs, and only differences will be described.

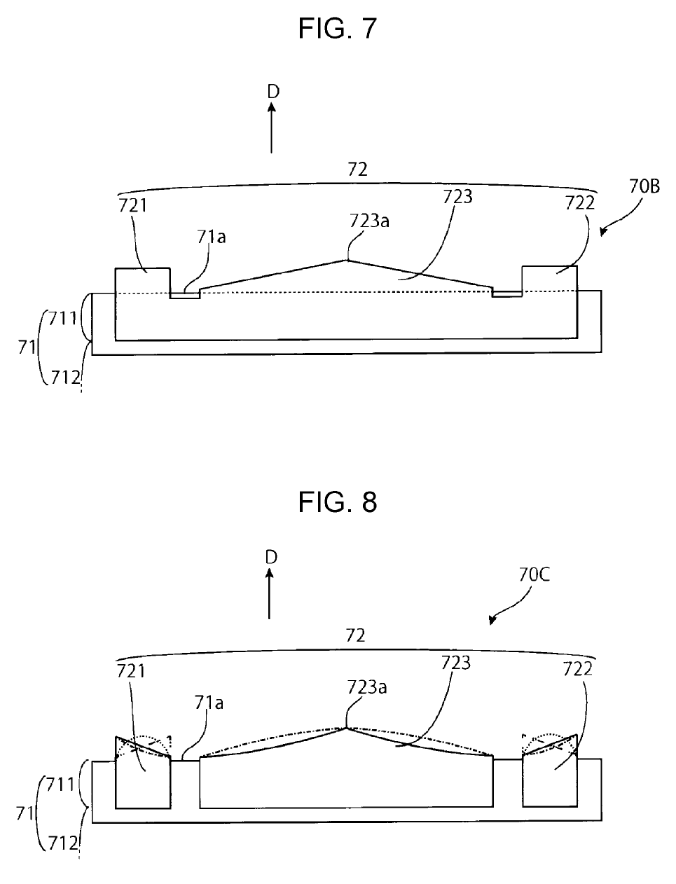

FIG. 7 is a schematic plan view illustrating the second example of the sheet-guide plate.

Similar to the case illustrated in FIGS. 3A to 3C, only an end portion of a sheet-guide plate 70B, the end portion being close to the second transfer position T (see FIG. 1 and FIG. 2), is illustrated in FIG. 7. This is common to the drawings subsequent to FIG. 7.

The sheet-guide plate 70B includes a guide member 71 and a flexible member 72 that is formed of, for example, a PET film and that is joined to an end portion 711 of the guide member 71, the end portion 711 being located on the side on which the second transfer position T is present. In the first example, which is illustrated in FIGS. 3A to 3C, the flexible member 72 is separated into the pair of end-guide flexible members 721 and 722 and the central-guide flexible member 723, and the pair of end-guide flexible members 721 and 722 and the central-guide flexible member 723 are joined to the end portion 711 of the guide member 71. In contrast, in the sheet-guide plate 70B, which is the second example illustrated in FIG. 7, the flexible member 72 is formed of a single film-shaped member including a pair of end-guide flexible members 721 and 722 and a central-guide flexible member 723 integrally connected to one another.

The flexible member 72 may be a single film-shaped member formed of the pair of end-guide flexible members 721 and 722 and the central-guide flexible member 723 that are integrally connected to one another as described above. However, employing the structure in which the pair of end-guide flexible members 721 and 722 and the central-guide flexible member 723 are separated from one another as in the first example illustrated in FIGS. 3A to 3C helps save material.

FIG. 8 is a schematic plan view illustrating a third example of the sheet-guide plate.

As in the first example illustrated in FIGS. 3A to 3C, a flexible member 72 that is included in a sheet-guide plate 70C, which is the third example illustrated in FIG. 8, is separated into a pair of end-guide flexible members 721 and 722 and a central-guide flexible member 723, and the pair of end-guide flexible members 721 and 722 and the central-guide flexible member 723 are joined to an end portion 711 of the guide member 71. However, whereas, in the first example illustrated in FIGS. 3A to 3C, the amount of projection of each of the end-guide flexible members 721 and 722 from the end edge 71a is uniform in the width direction (the transverse direction in FIG. 8), in the sheet-guide plate 70C, which is the third example illustrated in FIG. 8, the end-guide flexible members 721 and 722 each have a shape in which the amount of projection thereof from an end edge 71a varies in the width direction. This amount of projection in the width direction may vary in a linear manner as indicated by a solid line or may vary in an arc-like manner as indicated by a one-dot chain line. Alternatively, each of the end-guide flexible members 721 and 722 may have a shape in which the amount of projection thereof varies, as indicated by a two-dot chain line, in an opposite manner to that indicated by the solid line. Alternatively, each of the end-guide flexible members 721 and 722 may have a shape in which the amount of projection decreases with increasing distance from the center thereof to opposite ends thereof as indicated by a dotted line.

In the case of employing the end-guide flexible members 721 and 722 in each of which the amount of projection thereof varies in the width direction as described above, deformation that occurs when the trailing end edge P21 of the sheet P2 comes close to the end of the flexible member 72 is larger than that in the case of employing the end-guide flexible members 721 and 722 in each of which the amount of projection thereof is uniform in the width direction as in the first example illustrated in FIG. 3, and impact that acts on the end portions of the sheet P2 in the width direction, which are indicated by circles E in FIGS. 6A and 6B, when the sheet P2 separates from the sheet-guide plate 70C is further reduced.

In addition, in the sheet-guide plate 70C, which is the third example illustrated in FIG. 8, the shape of the central-guide flexible member 723 is also different from that of the central-guide flexible member 723 in the first example illustrated in FIGS. 3A to 3C. In other words, whereas, in the first example illustrated in FIGS. 3A to 3C, the central-guide flexible member 723 has the shape in which the amount of projection thereof decreases from the apex 723a to the opposite ends in a linear manner, in the third example, the central-guide flexible member 723 has a shape in which the amount of projection thereof decreases in an arc-like manner. The arc shape may be an arc shape that sharpens an apex 723a as indicated by a solid line or may be an arc shape that blunts the apex 723a as indicated by a one-dot chain line. By devising such shapes of the central-guide flexible member 723, variations in deformation that occurs in the central-guide flexible member 723 when the trailing end edge P21 of the sheet P2 (see FIGS. 6A and 6B) is moved toward the end of the sheet-guide plate 70C may be adjusted.

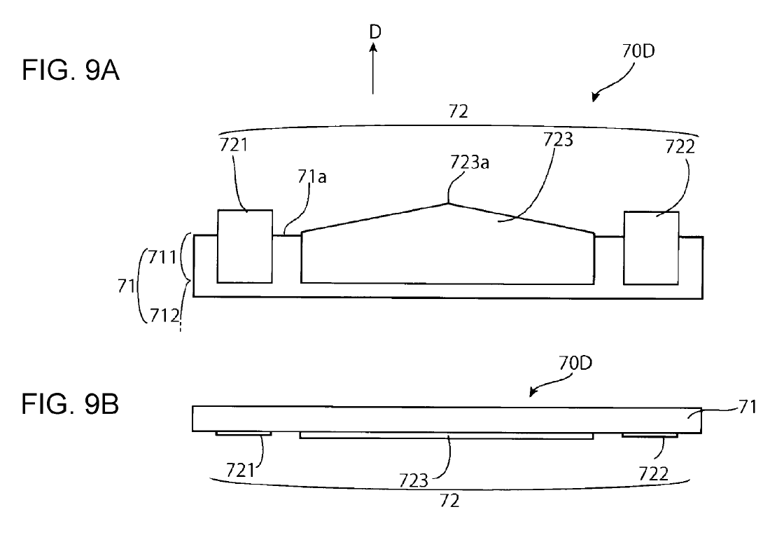

FIGS. 9A and 9B are schematic diagrams illustrating a fourth example of the sheet-guide plate. FIG. 9A is a plan view, and FIG. 9B is a front view.

In the sheet-guide plate 70A, which is the first example illustrated in FIGS. 3A to 3C, the end-guide flexible members 721 and 722 and the central-guide flexible member 723 are film-shaped members that are made of the same material and that have the same thickness. In contrast, in a sheet-guide plate 70D, which is the fourth example illustrated in FIGS. 9A and 9B, although the central-guide flexible member 723 and the end-guide flexible members 721 and 722 are members that are made of the same material, the thickness of the central-guide flexible member 723 is larger than the thickness of each of the end-guide flexible members 721 and 722 as illustrated in FIG. 9B. In other words, in the fourth example, the central-guide flexible member 723 has flexibility lower than that of each of the pair of end-guide flexible members 721 and 722 in order to make these members compatible with the sheet P1 (see FIGS. 5A to 5C), which is a small-sized thick sheet such as a postcard, and the sheet P2 (see FIGS. 6A and 6B), which is a large-sized normal sheet. When the sheet P1, which is a thick sheet, is used, the central-guide flexible member 723 is strongly pushed by the sheet P1 with high elasticity, and thus, the central-guide flexible member 723 needs to have elasticity high enough to resist being pushed. In contrast, the sheet P2, which is a normal sheet, has low elasticity and pushes the flexible member 72 only lightly. Thus, by making the flexibility of the central-guide flexible member 723 lower than that of each of the end-guide flexible members 721 and 722, the flexible member 72 may be formed to be further suitable for impact absorption with respect to the small-sized hard sheet P1 and the large-sized soft sheet P2 compared with the case where the central-guide flexible member 723 and the end-guide flexible members 721 and 722 have the same flexibility. Note that, although the flexibility of the flexible member 72 is adjusted by setting the thickness of the central-guide flexible member 723 to be different from the thickness of each of the end-guide flexible members 721 and 722, the flexibility of the central-guide flexible member 723 or the flexibility of each of the end-guide flexible members 721 and 722 may be adjusted by forming the central-guide flexible member 723 out of a material different from the material of the end-guide flexible members 721 and 722 while setting the thickness of the central-guide flexible member 723 and the thickness of each of the end-guide flexible members 721 and 722 to be the same as each other or while setting the thickness of the central-guide flexible member 723 and the thickness of each of the end-guide flexible members 721 and 722 to be different from each other.

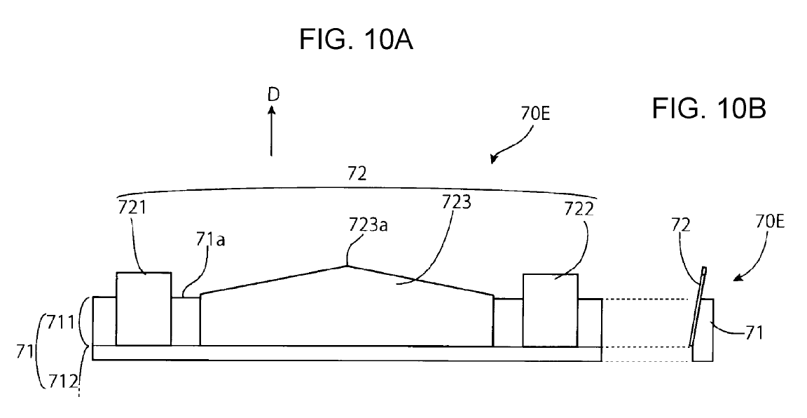

FIGS. 10A and 10B are schematic diagrams illustrating a fifth example of the sheet-guide plate. FIG. 10A is a plan view, and FIG. 10B is a side view.

In the sheet-guide plate 70A, which is the first example illustrated in FIGS. 3A to 3C, the entire guide member 71 including the end portion 711 is a member having a flat plate-like shape. In contrast, in the fifth example illustrated in FIGS. 10A and 10B, a surface of an end portion 711 of a guide member 71, the surface facing one of the sheets P, is a surface that is inclined in a direction toward the intermediate transfer belt 61 (see FIG. 1 and FIG. 2). A flexible member 72 (a central-guide flexible member 723 and a pair of end-guide flexible members 721 and 722) is joined to the inclined surface. The shape and the like of the flexible member 72 are the same as those of the flexible member 72 in the sheet-guide plate 70A, which is the first example illustrated in FIGS. 3A to 3C.

When a surface of the projecting portion according to the aspect of the present invention including the end portion 711 of the guide member 71 and the flexible member 72, the surface facing one of the sheets P, is inclined in the direction toward the intermediate transfer belt 61 as described above, the trailing end of the sheet P will have been moved to a position closer to the intermediate transfer belt 61 immediately before the sheet P separates from a sheet-guide plate 70E.

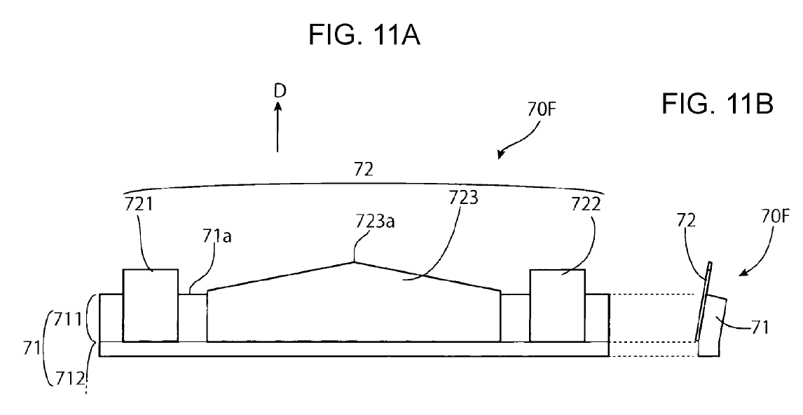

FIGS. 11A and 11B are schematic diagrams illustrating a sixth example of the sheet-guide plate. FIG. 11A is a plan view, and FIG. 11B is a side view.

In the sheet-guide plate 70E, which is the fifth example illustrated in FIGS. 10A and 10B, the end portion 711 of the guide member 71 has a shape in which only one surface thereof that faces one of the sheets P is inclined. In contrast, in the sixth example illustrated in FIGS. 11A and 11B, an end portion 711 of a guide member 71 has front and rear surfaces that are both inclined in the direction toward the intermediate transfer belt 61 (see FIG. 1 and FIG. 2). In other words, in the sixth example, the end portion 711 of the guide member 71 having a plate-like shape is bent obliquely with respect to a portion of the guide member 71 excluding the end portion 711. A flexible member 72 (a central-guide flexible member 723 and a pair of end-guide flexible members 721 and 722) is joined to the end portion 711, which is the bent portion. The shape and the like of the flexible member 72 are the same as those of the flexible member 72 in the sheet-guide plate 70A, which is the first example illustrated in FIGS. 3A to 3C.

In this manner, the projecting portion according to the aspect of the present invention including the end portion 711 of the guide member 71 and the flexible member 72 may be bent in the direction toward the intermediate transfer belt 61. Also in this case, similar to the fifth example illustrated in FIGS. 10A and 10B, the trailing end of one of the sheets P will have been moved to a position closer to the intermediate transfer belt 61 immediately before the sheet P separates from a sheet-guide plate 70F.

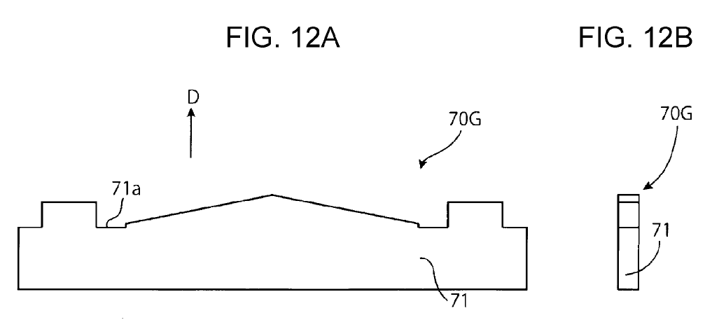

FIGS. 12A and 12B are schematic diagrams illustrating a seventh example of the sheet-guide plate. FIG. 12A is a plan view, and FIG. 12B is a side view.

Although the sheet-guide plates 70A to 70F, which are the above-described first to sixth examples, each have a structure in which the flexible member 72 is joined to the guide member 71, a sheet-guide plate 70G, which is the seventh example illustrated in FIGS. 12A and 12B, is formed of only a guide member 71. However, the shape of an end portion of the guide member 71 in plan view is the same as the shape of the sheet-guide plate 70A, which is the first example illustrated in FIGS. 3A to 3C, including the flexible member 72. In this case, in an end edge of the guide member 71 that has projections and depressions and that is located on the side on which the second transfer position T is present, a portion that is located on the most upstream side in the sheet-transport direction may be defined as the end edge 71a, which corresponds to an example of the reference end edge according to the aspect of the present invention.

The end portion of the sheet-guide plate 70G, which is the seventh example, has flexibility lower than that of the end portion of the sheet-guide plate 70A, which is illustrated in FIGS. 3A to 3C and which includes the flexible member 72, and absorb impact is realized only by the shape of the end portion. Consequently, the impact-absorbing function of the sheet-guide plate 70G is lower than that of the sheet-guide plate 70A, which is illustrated in FIGS. 3A to 3C and which includes the flexible member 72. However, if the impact-absorbing function of the sheet-guide plate 70G is sufficient, the sheet-guide plate may be formed of only the guide member 71, so that the manufacturing costs of the sheet-guide plate may be reduced.

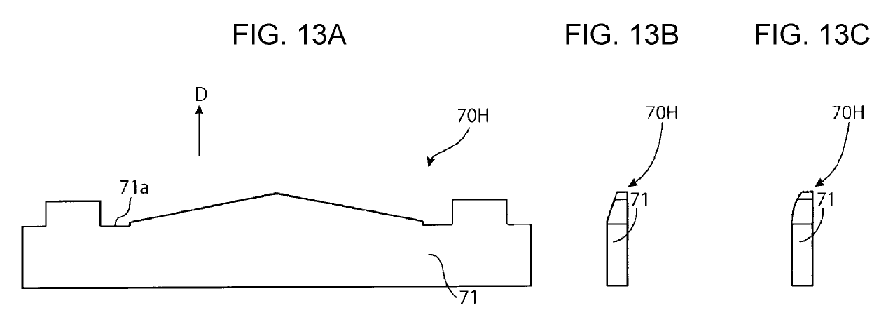

FIGS. 13A to 13C are schematic diagrams illustrating an eighth example of the sheet-guide plate. FIG. 13A and FIG. 13B are a plan view and a side view, respectively, and FIG. 13C is a side view of a modification of the eighth example.

Similar to the sheet-guide plate 70G, which is the seventh example illustrated in FIGS. 12A and 12B, a sheet-guide plate 70H, which is the eighth example illustrated in FIGS. 13A to 13C, is formed of only a guide member 71. In addition, similar to the sheet-guide plate 70E, which is the fifth example illustrated in FIGS. 10A and 10B, in the sheet-guide plate 70H, which is the eighth example, a surface of an end portion of the guide member 71, the surface facing one of the sheets P, is inclined in the direction toward the intermediate transfer belt 61.

For example, in the case where the sheet-guide plate 70H includes the flexible member 72 like the sheet-guide plate 70A, which is the first example illustrated in FIGS. 3A to 3C, impact is further absorbed as a result of the flexible member 72 deforming toward the intermediate transfer belt 61. However, in the sheet-guide plate 70H, which is the eighth example, instead of providing the flexible member 72 and causing the flexible member 72 to deform, the surface of the end portion that faces one of the sheets P is inclined, so that the impact-absorbing function is improved. In other words, as a result of causing the surface of the end portion of the guide member 71 that faces one of the sheets P to be inclined in the direction toward the intermediate transfer belt 61, the trailing end of the sheet P will have been closer to the intermediate transfer belt 61 immediately before the sheet P separates from the sheet-guide plate 70H compared with the case of the sheet-guide plate 70G, which is the seventh example illustrated in FIGS. 12A and 12B and which has the end portion that is not inclined. Instead of causing the surface of the end portion of the guide member 71 that faces the sheet P to be inclined, the surface may be curved toward the intermediate transfer belt 61 as illustrated in FIG. 13C.

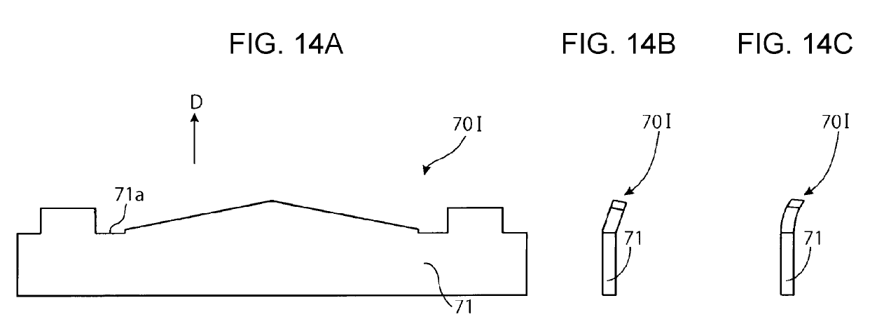

FIGS. 14 are schematic diagrams illustrating a ninth example of the sheet-guide plate. FIG. 14A and FIG. 14B are a plan view and a side view, respectively, and FIG. 14C is a side view of a modification of the ninth example.

Similar to the sheet-guide plate 70G, which is the seventh example illustrated in FIGS. 12A and 12B, and the sheet-guide plate 70H, which is the eighth example illustrated in FIGS. 13A to 13C, a sheet-guide plate 701, which is the ninth example illustrated in FIGS. 14, is formed of only a guide member 71. However, in the sheet-guide plate 701, which is the ninth example, an end portion of the guide member 71 having a plate-like shape is inclined in the direction toward the intermediate transfer belt 61 as a result of being bent with respect to a portion of the guide member 71 excluding the end portion.

Similar to the sheet-guide plate 70H, which is the eighth example illustrated in FIGS. 13A to 13C, in the sheet-guide plate 701, which is the ninth example illustrated in FIGS. 14, instead of providing the flexible member 72 and causing the flexible member 72 to deform, the end portion is inclined, so that the impact-absorbing function of the sheet-guide plate 701 is improved. In other words, as a result of causing the end portion of the guide member 71 to be inclined in the direction toward the intermediate transfer belt 61, the trailing end of one of the sheets P will have been closer to the intermediate transfer belt 61 immediately before the sheet P separates from the sheet-guide plate 701 compared with the case of the sheet-guide plate 70G, which is the seventh example illustrated in FIGS. 12A and 12B and which has the end portion that is not inclined. Instead of causing the end portion of the guide member 71 to be inclined, the end portion may be curved toward the intermediate transfer belt 61 as a result of being bent with respect to the other portion of the guide member 71 as illustrated in FIG. 14C.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a toner-image holding unit that holds an unfixed toner image and transports the unfixed toner image to a transfer position;
a sheet-guide unit that is brought into contact with a first surface of a sheet that is transported to the sheet-guide unit, the first surface facing the toner-image holding unit, and guides the sheet to the transfer position; and
a transfer unit that nips the sheet, which is guided to the transfer unit by the sheet-guide unit, between the transfer unit and the toner-image holding unit at the transfer position and that transfers the unfixed toner image transported by the toner-image holding unit onto the sheet,
wherein the sheet-guide unit includes a projecting portion including
a pair of end guide portions that project further toward the transfer position than a reference end edge does, the reference end edge facing the transfer position, and that are arranged on opposite sides of a central guide portion in a width direction that crosses a sheet-transport direction and
the central guide portion that is disposed at the center position between the pair of end guide portions in the width direction and that projects toward the transfer position while an amount of projection of the central guide portion decreases from an apex of the central guide portion, which is closer to the transfer position than the end edge is, toward opposite ends of the central guide portion in the width direction.

2. The image forming apparatus according to claim 1,
wherein an amount of projection of the apex from the end edge is equal to or larger than an amount of projection of each of the pair of end guide portions from the end edge.

3. The image forming apparatus according to claim 1,
wherein at least a surface of the projecting portion, the surface facing the sheet, is inclined or curved in a direction toward the toner-image holding unit.

4. The image forming apparatus according to claim 3,
wherein front and rear surfaces of the projecting portion are both inclined or curved in the direction toward the toner-image holding unit.

5. The image forming apparatus according to claim 1,
wherein at least a portion of the projecting portion that projects from the end edge has flexibility higher than flexibility of a portion of the sheet-guide unit, the portion being located further upstream than the projecting portion in the sheet-transport direction.

6. The image forming apparatus according to claim 1,
wherein the sheet-guide unit includes a guide member whose end edge facing the transfer position is the end edge and that extends further toward the upstream side in the sheet-transport direction than the end edge does, and
wherein the projecting portion includes a film-shaped flexible member projecting from the end edge and an end portion of the guide member that is located on the end edge side and to which the flexible member is fixed.

7. The image forming apparatus according to claim 6,
wherein the flexible member is separated into a pair of end-guide flexible members that are included in the pair of end guide portions and a central-guide flexible member that is included in the central guide portion, and the pair of end-guide flexible members and the central-guide flexible member are fixed to the end portion.

8. The image forming apparatus according to claim 7,
wherein opposite ends of the central-guide flexible member in the width direction project beyond the end edge.

9. The image forming apparatus according to claim 7,
wherein each of the pair of end-guide flexible members has a shape in which an amount of projection of the end-guide flexible member from the end edge varies in the width direction.

10. The image forming apparatus according to claim 7,
wherein the central-guide flexible member has flexibility lower than flexibility of each of the end-guide flexible members.
